(19) United States
(12) Patent Application Publication
(10) Pub. No.: US 2013/0009392 A1
(43) Pub. Date: Jan. 10, 2013

(54) Anti-Counterfeit Self-Adhesive Labels And Its Manufacturing Method

(75) Inventors: Miao Xiaowei, Wenzhou City (CN); Li Dianqi, Chenzhou City (CN)

(73) Assignee: BOA SHEN PAPER & PLASTIC PRODUCT CO., LTD., Guangzhou City (CN)

(21) Appl. No.: 13/540,970

(22) Filed: Jul. 3, 2012

(30) Foreign Application Priority Data
Jul. 4, 2011 (CN) CN201110184728.0

(51) Int. Cl. B42D 15/00

(52) U.S. Cl. 283/81

(57) ABSTRACT

An anti-counterfeit self-adhesive label has a self-adhesive cloth layer; a release film layer overlies said self-adhesive cloth layer; a micro-patterned layer containing miniature characters or graphics overlies said release film layer; and a laser anti-counterfeit film layer overlies said micro-patterned layer. Its manufacturing method includes design and typeset the characters or graphics under enlarged pattern, then convert such characters or graphics into the miniature colored pattern; the release film is applied onto the top surface of the self-adhesive cloth layer, whereby a release film layer is formed on the top surface of the self-adhesive cloth layer; the miniature characters or graphics are imprinted onto the top surface of the release film layer of the self-adhesive cloth layer to form a micro-patterned layer; apply a layer of laser anti-counterfeit film onto the top surface of the micro-patterned layer containing miniature characters or graphics to form a laser anti-counterfeit film layer.

### CROSS-REFERENCE TO RELATED APPLICATIONS

The present application claims priority from Chinese Patent Application No. 201110184728.0 filed Jul. 4, 2011, the disclosure of which is incorporated herein by reference.

### FIELD OF THE INVENTION

The present invention relates to a kind of anti-counterfeit label, especially a kind of anti-counterfeit self-adhesive label and its manufacturing method.

### BACKGROUND TECHNOLOGY

Anti-counterfeit refers to some measures taken to prevent imitating, copying or counterfeiting activities. Such activities aim to cheat and are unauthorized by the rights owners. Micro-patterned anti-counterfeit technology guarantees that the cryptograph can be read relying on high power microscope. Such technology has the advantage of being easy to check authenticity and being highly covert. The dealers concerned can perform inspection on the products based on the cryptograph. Laser anti-counterfeit technology can fulfill anti-counterfeit function by adding a layer of laser film. At present these two technologies are respectively applied in packaging.

### Invention Content

The purpose of the present invention is to provide a kind of anti-counterfeit self-adhesive label which combines the micro-patterned anti-counterfeit technology and the laser anti-counterfeit technology, as well as the manufacturing method of such label.

The technical solution of the present invention is as follows:
The anti-counterfeit self-adhesive label has a self-adhesive cloth layer; a release film layer overlies said self-adhesive cloth layer; a micro-patterned layer containing miniature characters or graphics overlies said release film layer; and a laser anti-counterfeit film layer overlies said micro-patterned layer.

The manufacturing method of such anti-counterfeit self-adhesive label in the present invention is as follows:
a. Typeset the designed characters or graphics, wherein the first step is to design and typeset the characters or graphics under enlarged pattern, secondly implant such characters or graphics into the right place as desired, then with the color-separation mode of digital printing, convert such characters or graphics into the miniature colored pattern in accordance with hue, color intensity and saturation;
b. Proofread and confirm. Proofread and check out the typesetted miniature colored characters or graphics, so as to make sure that such miniature pattern meets the requirements of digital printing and subsequent manufacturing process;
c. At normal (room) temperature, the release film is applied onto the top surface of the self-adhesive cloth layer for three to five times, and then the drying process is performed, whereby a release film layer is formed on the top surface of the self-adhesive cloth layer;
d. Digital printing is performed at the temperature of 145° C. and with the humidity of 50%, whereby the miniature characters or graphics can be imprinted onto the top surface of the release film layer of the self-adhesive cloth layer, so as to form a micro-patterned layer on the top surface of the release film layer;
e. Apply a layer of laser anti-counterfeit film onto the top surface of the micro-patterned layer containing miniature characters or graphics, so as to form a laser anti-counterfeit film layer on the top surface of said micro-patterned layer.
f. Die-cut the anti-counterfeit self-adhesive label in accordance with the required specifications of subsequent manufacturing process and then perform quality testing.
g. Test and package the end product of the anti-counterfeit self-adhesive labels.

One advantage of the present invention is to combine the micro-patterned anti-counterfeit technology with the laser anti-counterfeit technology to boost the label's anti-counterfeit function. In the meantime, the manufacturing process of such anti-counterfeit self-adhesive label is simple and the production cost thereof is also low.

### DESCRIPTION OF THE DRAWINGS

FIG. 1 is the schematic drawing of the anti-counterfeit self-adhesive label of the present invention.

FIG. 2 is the flow chart of the manufacturing process of the anti-counterfeit self-adhesive label of the present invention.

### DETAILED DESCRIPTION OF THE EMBODIMENTS

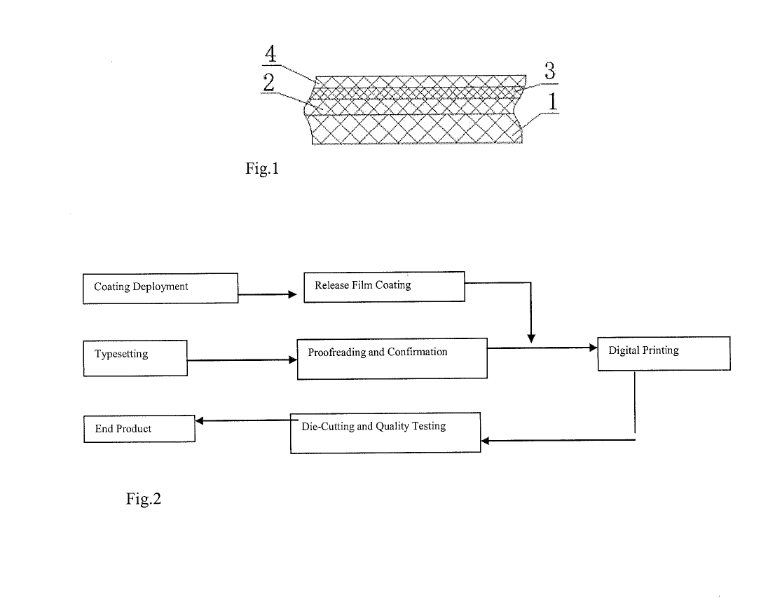

As illustrated in FIG. 1, the substrate of said anti-counterfeit self-adhesive label in the present invention is the self-adhesive cloth layer 1; a release film layer 2 is applied onto the top surface of said self-adhesive cloth layer 1; a micro-patterned layer 3 containing miniature characters or graphics is imprinted onto the top surface of said release film layer 2; and a laser anti-counterfeit film layer 4 overlies said micro-patterned layer 3 containing miniature characters or graphics.

As illustrated in FIG. 2, the manufacturing steps of the anti-counterfeit self-adhesive label of the present invention are as follows:
a. Typeset the designed characters or graphics, wherein the first step is to design and typeset the characters or graphics under enlarged pattern, secondly implant such characters or graphics into the right place as desired, then based on the proportional distribution of CMYK employed in the color-separation mode of digital printing, convert such characters or graphics into the miniature colored pattern in accordance with hue, color intensity and saturation;
b. Proofread and confirm. Proofread and check out the typesetted miniature colored characters or graphics, so as to make sure that such miniature pattern meets the requirements of digital printing and subsequent manufacturing process;
c. At normal (room) temperature, the release film is applied onto the top surface of the self-adhesive cloth layer 1 for three to maximal five times, and then the drying process is performed, whereby a release film layer 2 is formed on the top surface of the self-adhesive cloth layer 1;
d. Digital printing is performed at the temperature of 145° C. and with the humidity of 50%, whereby the miniature characters or graphics can be imprinted onto the top surface of the release film layer 2 of the self-adhesive cloth layer 1, so as to form a micro-patterned layer 3 containing miniature characters or graphics on the top surface of the release film layer 2;
e. Apply a layer of laser anti-counterfeit film onto the top surface of the micro-patterned layer 3 containing miniature characters or graphics, so as to form a laser anti-counterfeit film layer 4 on the top surface of said micro-patterned layer 3.
f. Die-cut the anti-counterfeit self-adhesive label in accordance with the required specifications of subsequent manufacturing process and then perform quality testing.
g. Test and package the end product of the anti-counterfeit self-adhesive labels.

1. A kind of anti-counterfeit self-adhesive label, which is characterized with the following features:
The anti-counterfeit self-adhesive label has a self-adhesive cloth layer; a release film layer overlies said self-adhesive cloth layer; a micro-patterned layer containing miniature characters or graphics overlies said release film layer; and a laser anti-counterfeit film layer overlies said micro-patterned layer.

2. A manufacturing method of the anti-counterfeit self-adhesive label is characterized by the following procedures:
a. Typeset the designed characters or graphics, wherein the first step is to design and typeset the characters or graphics under enlarged pattern, secondly implant such characters or graphics into the right place as desired, then with the color-separation mode of digital printing, convert such characters or graphics into the miniature colored pattern in accordance with hue, color intensity and saturation;
b. Proofread and confirm. Proofread and check out the typesetted miniature colored characters or graphics, so as to make certain that such miniature pattern meets the requirements of digital printing and subsequent manufacturing process;
c. At normal (room) temperature, the release film is applied onto the top surface of the self-adhesive cloth layer for three to five times, and then the drying process is performed, whereby a release film layer is formed on the top surface of the self-adhesive cloth layer;
d. Digital printing is performed at the temperature of 145° C. and with the humidity of 50%, whereby the miniature characters or graphics can be imprinted onto the top surface of the release film layer of the self-adhesive cloth layer, so as to form a micro-patterned layer on the top surface of the release film layer;
e. Apply a layer of laser anti-counterfeit film onto the top surface of the micro-patterned layer containing miniature characters or graphics, so as to form a laser anti-counterfeit film layer on the top surface of said micro-patterned layer.
f. Die-cut the anti-counterfeit self-adhesive label in accordance with the required specifications of subsequent manufacturing process and then perform quality testing.
g. Test and package the end product of the anti-counterfeit self-adhesive labels.
